(19) United States
(12) Patent Application Publication
(10) Pub. No.: US 2009/0314708 A1
(43) Pub. Date: Dec. 24, 2009

(54) Hollow fiber membrane for feeding mixture into hollow space thereof

(75) Inventor: Choong Kyun Yeom, Incheon (KR)

Correspondence Address: STAAS & HALSEY LLP, SUITE 700, 1201 NEW YORK AVENUE, N.W., WASHINGTON, DC, 20005, US

(73) Assignee: SepraTek Inc., Incheon (KR)

(21) Appl. No.: 12/213,360

(22) Filed: Jun. 18, 2008

(51) Int. Cl. B01D 39/14; D02G 3/22

(52) U.S. Cl. 210/500.23; 428/376; 428/313.9; 428/332; 55/524

(57) ABSTRACT

Disclosed herein is a hollow fiber membrane for feeding a mixture into the hollow space thereof, in which the mixture to be separated is fed into the hollow space of the hollow fiber membrane and allowed to permeate through a porous membrane comprising an active layer. The hollow fiber membrane is manufactured by forming a tubular active layer having a hollow space and making a polymer fiber braid, a metal wire braid or a braid consisting of a mixture of polymer fiber with metal wire, directly on the outer surface of the tubular layer, such that the active layer can be prevented from being expanded if a high-temperature, high-pressure mixture is fed into the hollow space.

### BACKGROUND OF THE INVENTION

1. Field of the Invention

The present invention relates to a hollow fiber membrane, and more particularly to a hollow fiber membrane for feeding a mixture into the hollow space thereof, in which the mixture to be separated is fed into the hollow space of the hollow fiber membrane and allowed to permeate through an active layer-containing porous membrane (hereinafter, simply referred to as “active layer”).

2. Background of the Related Art

In general, when a mixture is separated into its components through a hollow fiber membrane, the mixture to be separated (hereinafter, also referred to as “feed mixture”) is fed outside the hollow fiber membrane, and pressure is applied thereto, such that the material permeated through the hollow fiber membrane is discharged into the hollow space of the hollow fiber membrane. This is because, if the mixture to be separated is fed into the hollow space of the hollow fiber membrane and pressurized, the membrane will broken down at 5-10 atm due to its low pressure resistance.

In the prior art, braid-reinforced hollow fiber membranes, comprising an active layer formed on the outer surface of a braid made of, for example, polymer fiber, have been used. However, the braid-reinforced hollow fiber membranes also had the following problems, when a mixture to be separated is fed into the hollow space thereof to separate it into its components.

That is, the active layer applied to the outer surface of the polymer fiber braid can somewhat resist external pressure applied to the outside of the hollow fiber membrane, because the braid functions as a reinforcing material. However, there is a problem in that, when the feed mixture is fed into the hollow space and pressurized, the active layer is easily broken down, because the applied internal pressure acts directly on the active layer, applied on the outer surface of the braid, through the gap of the braid. Because of the low resistance of the hollow fiber membrane against the internal pressure, a method for separating the feed mixture into its components generally comprises feeding the feed mixture to the outside of the hollow fiber membrane and recovering the permeate from the hollow space of the hollow fiber membrane.

However, in this method comprising feeding the mixture to the outside of the membrane and recovering the permeate from the hollow space, a dead volume is introduced in the membrane module to increase the amount of feed mixture required, and the rate of contact of the feed mixture with the membrane surface is reduced to increase the necessary membrane area. Particularly, the feed mixture flows along the length of the hollow fibers between the hollow fibers in the hollow fiber membrane bundle to cause a channeling phenomenon of forming a feed mixture film occurs, and for this reason, when various kinds of feed mixtures are fed, the feed mixtures are not sufficiently mixed with each other, thus reducing the efficiency of separating the mixtures.

The braid of the braid-reinforced hollow fiber membrane is made mainly of polymer fiber, such as polyester, nylon, aramid, polypropylene or polyethylene fiber, and in the case of hollow fiber membranes for use in high-temperature separation membrane processes, glass fiber is also used as a material for making the braid. The thickness and inner diameter of the braid are determined depending on the kind of polymer fiber used to make the braid, the thickness (denier) of each filament of yarn, the number of the filaments, and the number of strands of yarn used to make the braid. Although a suitable polymer fiber material is selected depending on the intended use of the braid-reinforced hollow fiber membranes, the use of the braid-reinforced hollow fiber membranes is limited mainly to membrane separation processes of treating non-solvent solutions at room temperature. This is because the braid-reinforced hollow fiber membranes show high tensile strength, that is, show very excellent properties against loads acting in the lengthwise direction of the membrane, but show poor properties against loads acting in the direction perpendicular to the membrane surface, particularly the pressure applied from the inside to the outside of the membrane. For example, when the feed mixture is fed into the hollow space of the polymer fiber braid-reinforced hollow fiber membrane in reverse osmosis membrane separation processes at a pressure higher than 20 atm, the braid is expanded by pressure in the radial direction and, as a result, the active layer applied on the braid is damaged, thus causing deterioration in the membrane performance. Thus, making the braid on the outside surface of the hollow fiber membrane is not of great help in increasing the pressure resistance of the hollow fiber membrane when the mixture to be separated is fed into the hollow fiber membrane at high temperature and high pressure.

### SUMMARY OF THE INVENTION

The present invention has been made in order to solve the problems with the above-described prior hollow fiber membranes, and it is an object of the present invention to provide a hollow fiber membrane for feeding a mixture into the hollow space thereof, in which a high-temperature, high-pressure mixture can be fed into the hollow space of the hollow fiber membrane and separated into its components.

Another object of the present invention is to provide a hollow fiber membrane for feeding a mixture into the hollow space thereof, which can fundamentally prevent the channeling of a feed mixture, which can occur when the mixture is fed to the outside of hollow fiber membranes and separated into its components.

Still another object of the present invention is to provide a hollow fiber membrane for feeding a mixture into the hollow space thereof, in which the rate of contact of the mixture with the membrane surface can be increased, such that the mixture separation efficiency of the membrane can be increased.

To achieve the above objects, the present invention provides a hollow fiber membrane for feeding a mixture into the hollow space thereof, which is manufactured by forming a tubular active layer having a hollow space and making a polymer fiber braid, a metal wire braid or a braid consisting of a mixture of polymer fiber with metal wire, directly on the outer surface of the tubular active layer, such that the active layer can be prevented from being expanded if a high-temperature, high-pressure mixture is fed into the hollow space.

Due to an intrinsic limitation on the pressure resistance of hollow fiber membranes made of polymer material, the sufficient mechanical strength of the hollow fiber membrane, which can resist the pressure of a high-pressure feed mixture, must be ensured to feed the mixture into the hollow fiber membrane and then separate the mixture into its components. When the mechanical strength of the hollow fiber membrane, the hollow space of which is fed with the mixture, is to be ensured by a braid, the braid must be located on the outside of the active layer of the membrane. For this purpose, in the present invention, a tubular active layer is formed, and a braid is made directly on the outside of the active layer. In this case, the braid having excellent properties as a reinforcing material can cope with pressure applied to the inside of the hollow fiber membrane so as to support the hollow fiber membrane. Herein, the active layer may be formed in the form of a composite membrane, which consists of an outer porous layer and an inner active layer which is more compact than the outer porous layer. When the outer layer is formed of porous material and when the inner active layer, which is more compact than the outer porous layer, is formed inside the outer porous layer, the active layer has sufficient mechanical strength which can resist the pressure of a feed mixture, even if the feed mixture has high pressure.

Permissible pressure and permissible temperature are determined depending on the material of the braid. Because a braid made of polymer fiber is unstable upon exposure to high pressure, high pressure and organic solvents, the physical properties of the braid need to be improved. In comparison with polymer fiber, a metal material has significantly excellent mechanical properties and, in addition, has excellent dimensional stability, because it is heat-resistant and has no affinity for organic solvents upon contact with the organic solvents. Thus, the braid according to the present invention may be made either of a mixture of polymer fiber with metal wire or only of metal wire.

In the case where the braid is made only of metal wire, the mechanical properties and dimensional stability of the braid become excellent, but the braid itself becomes hard, and thus the rough surface of the braid can damage the active layer located therein, particularly in high-pressure processes, and in addition, the handling property thereof becomes poor, when it is manufactured into modules. Thus, in a hollow fiber membrane to be used in high-temperature and high-pressure conditions, it is preferable to replace part of the polymer fiber of the braid, that is, mix the polymer fiber with metal wire. In this case, the flexibility of the braid can be improved, and the stability of the produced braid against pressure and temperature and upon contact with organic solvents is determined mainly by the metal wire that is a major reinforcing material. As a result, because the braid made of a mixture of metal wire with polymer fiber is very stable even in conditions of high temperature, high pressure and contact with organic solvents, a membrane reinforced with this braid will also necessarily be stable. As the ratio of the metal wire in the braid made of the mixture of metal wire with polymer fiber is increased, the mechanical properties and dimensional stability of the braid become excellent, but the braid itself becomes hard, and thus the handling property thereof becomes poor, when it is manufactured into modules. On the other hand, if the ratio of the metal wire is reduced, the flexibility of the braid is increased to improve the handling property thereof, but the mechanical properties and dimensional stability thereof are deteriorated. Thus, the number of strands of the metal wire or the number of strands of the metal wire mixed with the polymer fiber in the braid made of the mixture of polymer fiber with metal wire is preferably 5-30% of the total number of strands of braided yarn in the braid. Also, each metal wire in the braid is braided while maintaining a constant distance from the adjacent wires. The metal wire for use in the present invention may be made of a material selected from among various materials, including copper, nickel, stainless steel, tin and nichrome, and the thickness of each metal wire is in the range of 0.05-0.4 mm depending on the size of hollow fiber membrane to be manufactured.

The polymer fiber that is used to make the braid is selected from among polyester, nylon, aramid, polypropylene and polyethylene fibers and may be used in the form of yarn. The yarn consists of a plurality of filaments, in which the thickness each of the filaments is 100-500 denier, and the number of the filaments is 10-400.

The thickness of each of the polymer fiber and the metal wire is determined depending on the thickness and diameter of braid to be produced, and in order to make the appearance of the braid uniform, the thickness of the metal wire is preferably substantially equal to the thickness of the polymer fiber.

The polymer fiber and the metal wire, which are used to make the braid, preferably have a total strand number of 10-80.

The active layer comprises a nanofiltration membrane, a reverse osmosis membrane, a vapor permeation membrane, a pervaporation membrane or a gas separation membrane.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1a is a partially sectioned perspective view of a braid-reinforced hollow fiber membrane according to a first embodiment of the present invention;

FIG. 1b is a cross-sectional view of the braid-reinforced hollow fiber membrane shown in FIG. 1a;

FIG. 1c shows the arrangement of metal wire bobbins and polymer fiber bobbins in the braid shown in FIG. 1a;

FIG. 2a is a partially sectioned perspective view of a braid-reinforced hollow fiber membrane according to a second embodiment of the present invention;

FIG. 2b is a cross-sectional view of the braid-reinforced hollow fiber membrane shown in FIG. 2a;

FIG. 2c shows the arrangement of metal wire bobbins and polymer fiber bobbins in the braid shown in FIG. 2a;

FIG. 3a is a partially sectioned perspective view of a braid-reinforced hollow fiber membrane according to a third embodiment of the present invention;

FIG. 3b is a cross-sectional view of the braid-reinforced hollow fiber membrane shown in FIG. 3a; and

FIG. 3c shows the arrangement of metal wire bobbins and polymer fiber bobbins in the braid shown in FIG. 3a.

### DETAILED DESCRIPTION OF THE PREFERRED EMBODIMENT

Hereinafter, preferred embodiments of a braid-reinforced hollow fiber membrane according to the present invention will be described in detail with reference to the accompanying drawings.

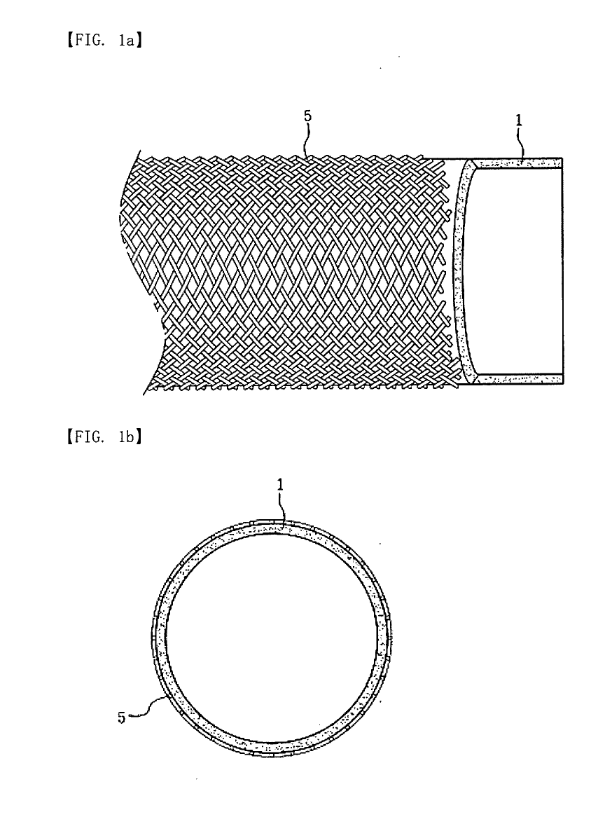

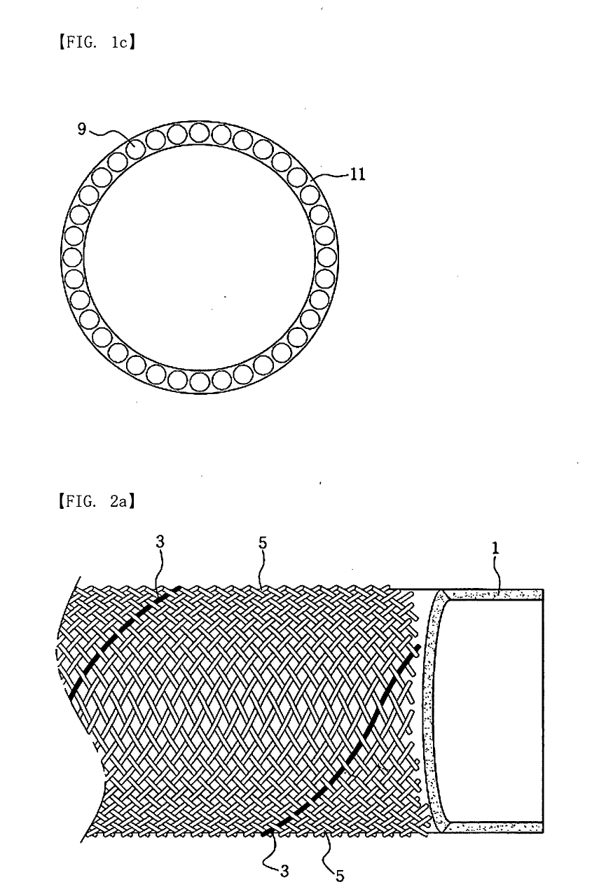

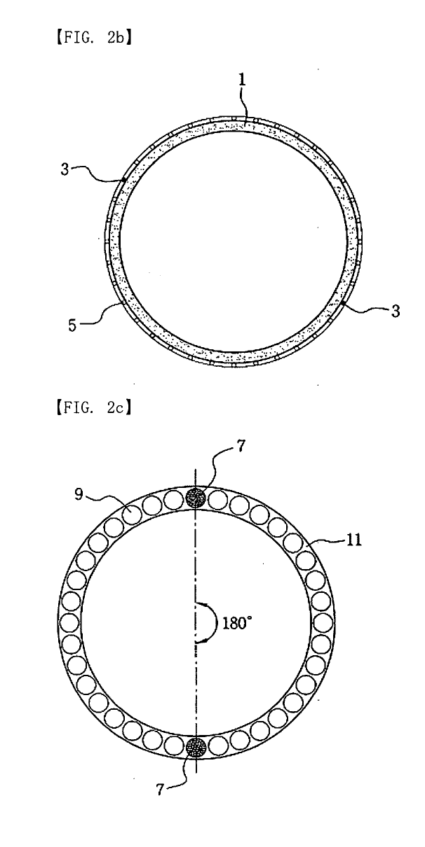

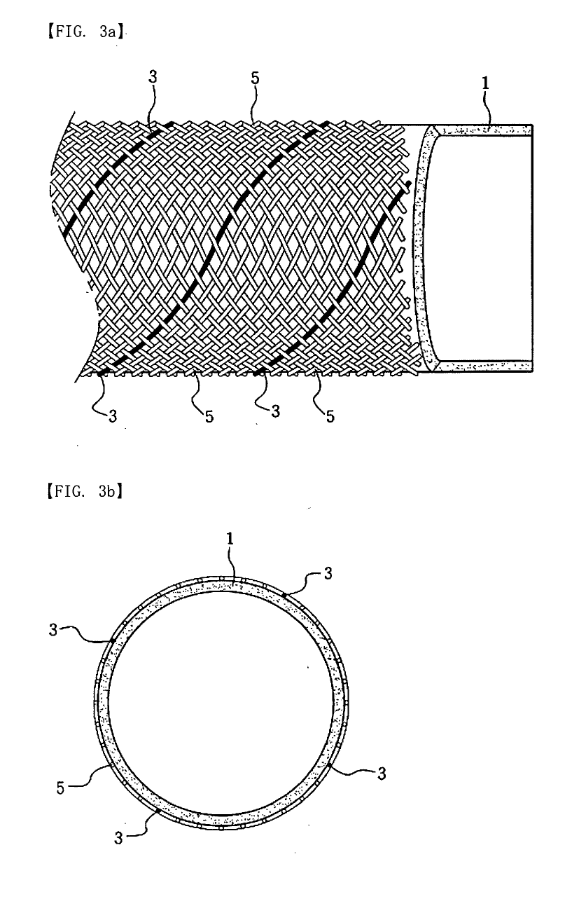

The first embodiment shown in FIGS. 1a and 1b show a braid formed by braiding only polymer fiber directly on the outside of an active layer 1, the second embodiment shown in FIGS. 2a and 2b show a braid formed by braiding a mixture of 2 strands of a metal wire 3 with 34 strands of a polymer fiber 5 directly on the outside of the active layer 1, and the third embodiment shown in FIGS. 3a and 3b show a braid formed by braiding a mixture of 4 strands of the metal wire 3 with 32 strands of the polymer fiber 5 directly on the outside of the active layer 1.

Referring to FIG. 1c, 2c or 3c, the braid is formed by feeding the previously formed tubular active layer 1 as a core into a braiding machine and, at the same time, braiding the polymer fiber 5, the metal wire 3 or a mixture of the polymer fiber 5 with the polymer fiber 3.

The polymer fiber 5 or the metal wire 3 is wound around the respective bobbins 7 and 9, which are placed in the ring-shaped carrier 11 of the braiding machine. Herein, the number of the placed bobbins is 10-80 which is equal to the number of strands used in the braiding.

When the metal wire is used in the braiding, although only the metal wire may be wound around the bobbins for use in the braid as shown in FIGS. 2a and 3a, the metal wire may also be mixed with the polymer fiber before the braiding and be used in the braiding. However, when only the metal wire is wound around the bobbins, the thickness of the metal wire must be larger than that of the metal wire in the mixture with the polymer fiber. Also, although FIGS. 2a and 3a illustratively show the use of a single metal wire as the metal wire, a metal wire assembly consisting of 2-5 thin metal wires may, if necessary, be used.

In the case where the braid is made of the mixture of polymer fiber with metal wire as in the second embodiment and the third embodiment, either metal wire bobbins 7 or metal wire bobbins 7 mixed with polymer fiber are placed in the braiding machine carrier 11 in an amount of 5-30% relative to the total number of bobbins placed in the carrier in order for the number of strands of the metal wire to be 5-30% of the total number of strands in the braid, as described above. Herein, in order to make the distance between the metal wire strands uniform, the metal wire bobbins 7 must be arranged symmetrically with respect to the center of the ring-shaped carrier 11 depending on the number thereof. If the metal wire bobbins are not arranged symmetrically with respect to the center of the carrier, the surface of the resulting braid becomes non-smooth and non-uniform.

When the tubular active layer 1 is supplied into the center of the ring-shaped carrier 11, and a given number of the braided yarn bobbins 7 and 9 rotate along the ring-shaped carrier 11, a braid is made on the outside of the supplied active layer 1. Herein, in order to maintain the closeness between the active layer 1 and the braid, the outer diameter of the active layer 1 before braiding is preferably 1.1-3.0 times the inner diameter of the braid formed without the active layer. This is because the outer diameter of the active layer 1 must be larger than the inner diameter of the braid formed without the active layer 1 in order to maintain the closeness between the active layer 1 and the braid formed on the outside of the active layer.

Hereinafter, the present invention will be described in further detail with reference to examples, and the properties of braid-reinforced hollow fiber membranes of the present invention will be compared with those of prior braid-reinforced hollow fiber membranes.

### EXAMPLE 1

500 g of polysulfone and 130 g of polyvinylpyrrolidone (PVP) were dissolved in 1370 g of dimethyl acetamide to prepare a uniform solution. The solution was cured in water at 35° C. to completely remove the remaining solvent and the additive PVP, and then was prepared into a tubular porous membrane having an inner diameter of 1.1 mm and an outer diameter of 1.9 mm. On the inner surface of the prepared porous tubular membrane, a polyvinylalcohol layer having a thickness of 2 μm was applied to form a tubular active layer. The formed active layer consisted of an outer porous layer and an inner active layer which was more compact than the outer layer. 36 strands of 300/150 polyester yarn were braided on the outside of the active layer to form a braid, thus manufacturing a hollow fiber membrane for feeding a mixture into the hollow space thereof, which had an outer diameter of about 2.9 mm.

### EXAMPLE 2

500 g of polysulfone and 130 g of polyvinylpyrrolidone (PVP) were dissolved in 1370 g of dimethyl acetamide to prepare a uniform solution. The solution was cured in water at 35° C. to completely remove the remaining solvent and the additive PVP, and then was prepared into a tubular porous membrane having an inner diameter of 1.1 mm and an outer diameter of 1.9 mm. On the inner surface of the prepared porous tubular membrane, a polyvinylalcohol layer having a thickness of 2 μm was applied to form a tubular active layer. The formed active layer consisted of an outer porous layer and an inner active layer which was more compact than the outer layer. 32 strands of 300/150 polyester yarn and 4 strands of stainless steel wire having a diameter of 0.2 mm were braided on the outside of the active layer, thus manufacturing a hollow fiber membrane for feeding a mixture into the hollow space thereof, which had an outer diameter of 2.9 mm.

### COMPARATIVE EXAMPLE 1

36 strands of 300/150 polyester yarn were used to make a braid having an outer diameter of 2 mm and an inner diameter of 1 mm. Meanwhile, 500 g of polysulfone and 130 g of polyvinylpyrrolidone (PVP) were dissolved in 1370 g of dimethyl acetamide to prepare a uniform solution. The solution was applied uniformly on the outer surface of the braid, and then cured in water, thus manufacturing a prior braid-reinforced hollow fiber membrane having a porous membrane. Polyvinylalcohol was applied on the surface of the porous membrane to a thickness of 2 μm.

### COMPARATIVE EXAMPLE 2

34 strands of 300/150 polyester yarn and 2 strands of stainless steel wire having a diameter of 0.2 mm were used to make a braid having an outer diameter of 2 mm and an inner diameter of 1 mm. Meanwhile, 500 g of polysulfone and 130 g of polyvinylpyrrolidone (PVP) were dissolved in 1370 g of dimethyl acetamide to prepare a uniform solution. The solution was applied uniformly on the outer surface of the braid, and then cured in water, thus manufacturing a prior braid-reinforced hollow fiber membrane having a porous membrane. Polyvinylalcohol was applied on the surface of the porous membrane to a thickness of 2 μm.

### COMPARATIVE EXAMPLE 3

32 strands of 300/150 polyester yarn and 4 strands of stainless steel wire having a diameter of 0.2 mm were used to make a braid having an outer diameter of 2 mm and an inner diameter of 1 mm. Meanwhile, 500 g of polysulfone and 130 g of polyvinylpyrrolidone (PVP) were dissolved in 1370 g of dimethyl acetamide to prepare a uniform solution. The solution was applied uniformly on the outer surface of the braid, and then cured in water, thus manufacturing a prior braid-reinforced hollow fiber membrane having a porous membrane. Polyvinylalcohol was applied on the surface of the porous membrane to a thickness of 2 μm.

In order to manufacture modules using the hollow fiber membranes manufactured in Examples and Comparative Examples, a 130-strand bundle of the hollow fiber membranes was filled in each of C-PVC tubes having a length of 1 m and an inner diameter of 1 inch, and both ends of the bundle was ported with epoxy resin. In pressure tests for the hollow fiber membrane manufactured in each of Examples and Comparative Examples, air having a pressure of each of 2 atm, 10 atm, 20 atm and 40 atm was applied inside the hollow fiber membrane, and the stability of the membranes was observed. Pervaporation tests for the manufactured hollow fiber membranes were carried out, in which a mixture feed used in the tests consisted of 95 wt % ethanol and 5 wt % water. In the pervaporation tests, the mixture feed was allowed to flow to the inside of the hollow fiber membranes for modules of the hollow fiber membranes of Examples 1, 2 and 3 and was allowed to flow to the outside of the hollow fiber membranes for modules of the hollow fiber membranes of Comparative Examples 1, 2 and 3, while a vacuum of 5 torr was applied to the opposite side. The used mixture feed had a temperature of 60° C. and an initial flow rate of 100 cc/min. In each of operating conditions, permeation rate through the membranes, the water content of permeates and the temperature of the feed mixture at the module inlet and outlet were measured.

Table 1 shows pressure test results for the membranes of Examples 1, 2 and 3 and Comparative Examples 1, 2 and 3. As shown in Table 1, in all the hollow fiber membranes having the active layer applied on the outer surface of the braid (Comparative Examples 1, 2 and 3), the applied active layer was broken down at a pressure higher than 10 atm. In comparison with this, the inventive hollow fiber membranes having the braid made on the outside of the active layer showed stability even at a pressure higher than 40 atm. However, in the case of the braid made only of polymer fiber (Example 1), the hollow fiber membrane and the braid were expanded in the radial direction by the internally applied pressure with the passage of time, so that the active layer thickness of the hollow fiber membrane became gradually thin, and thus the leakage of solute through the active layer did not occur, even though the hollow fiber membrane was not broken down. However, in the cases where the braids were made of the mixture of metal wire and polymer fiber Examples 2 and 3), the hollow fiber membranes showed excellent stability against pressure.

TABLE 1
Results of pressure stability tests for
hollow fiber membranes according to the present invention

| Hollow fiber | Air pressure applied into hollow fiber membranes (atm) | | | |
|---|---|---|---|---|
| membranes | 2 | 10 | 20 | 40 |
| Example 1 | Good | Good | Leakage through | Leakage through |
| | | | active layer after 4 hours | active layer after 2-3 hours |
| Example 2 | Good | Good | Good | Good |
| Example 3 | Good | Good | Good | Good |
| Comparative | Good | Active layer was | Active layer was | Active layer was |
| Example 1 | | broken down | broken down | broken down |
| Comparative | Good | | | |
| Example 2 | | | | |
| Comparative | Good | Active layer was | Active layer was | Active layer was |
| Example 3 | | broken down | broken down | broken down |

From the above results, it can be seen that, in the case where the braid was made on the outside of the active layer, the hollow fiber membrane showed excellent pressure resistance when the mixture was fed into the hollow space thereof. Also, it can be seen that, in the case where the braid was made using metal wire mixed with polymer fiber, the braid showed a significantly increased reinforcing effect.

TABLE 2
Results of pervaporation tests for hollow
fiber membranes according to the present invention

| | |
|---|---|
| Permeation | Feed |
| properties | temperature (° C.) |

| | Permeation | Water | Module | Module |
|---|---|---|---|---|
| | rate¹ | content² | inlet | outlet |
| Example 1 | 0.50 | 98.1 | 60 | 58 |
| Example 2 | 0.52 | 97.8 | 60 | 58 |
| Example 3 | 0.51 | 98.3 | 60 | 58 |
| Comparative | 0.34 | 96.2 | 60 | 56 |
| Example 1 | | | | |
| Comparative | 0.31 | 95.4 | 60 | 55 |
| Example 2 | | | | |
| Comparative | 0.36 | 95.4 | 60 | 55 |
| Example 3 | | | | |

¹permeation rate (kg/m² · hr) after 1 hour; and
²water content (wt %) of permeate after 1 hour.

Table 2 shows the pervaporation separation performance of the inventive hollow fiber membranes together with Comparative Examples. In the case of the inventive hollow fiber membranes having the braid formed in the outside of the active layer (Examples 1, 2 and 3), the feed mixture was allowed to flow into the hollow fiber membranes. However, in the case of the hollow fiber membranes having the active layer applied on the outer surface of the braid (Comparative Examples 1, 2 and 3), the feed mixture must have been allowed to flow to the outside of the hollow fiber membranes due to their low pressure resistance. In this case, the channeling of the feed mixture between the hollow fibers occurred, thus reducing permeation rate through the membrane and causing a decrease in the separation efficiency of the membrane. In the case of the inventive hollow fiber membranes in which the braid was made on the outside of the active layer, it can be seen that the channeling of the feed mixture did not occur and that, because the contact ratio of the feed mixture with the membranes was high, the membranes had high permeation rate and excellent separation efficiency. In addition, it can be seen that the difference in temperature of the feed mixture between the module inlet and the module outlet was significantly lower in the inventive hollow fiber membranes than in the hollow fiber membranes of Comparative Examples, suggesting that the heat loss rate of the feed mixture in the module of the inventive hollow fiber membranes was significantly low.

The above comparison demonstrates that the inventive hollow fiber membrane for feeding a mixture into the hollow space thereof shows excellent stability at high temperature and high pressure and has excellent permeation and separation performance.

The inventive hollow fiber membrane for feeding a mixture into the hollow space thereof has increased pressure resistance resulting from the support action of the braid having high mechanical strength. Thus, the inventive hollow fiber membrane is very suitable for high-temperature or high-pressure membrane separation processes, including nanofiltration, reverse osmosis, vapor permeation, pervaporation or gas separation processes and can achieve high separation efficiency.

As described above, according to the present invention, a high-temperature, high-pressure mixture can be fed into the hollow space of the hollow fiber membrane to separate the mixture into its components, and the dead volume in a membrane module is minimized, because the feed mixture flows within the hollow fiber membrane. Thus, the rate of contact of the feed mixture with the membrane surface can be increased to reduce a necessary membrane area, and a channeling phenomenon, which occurs when a mixture is fed to the outside of hollow fiber membranes, can be fundamentally solved. In addition, the outer braid layer functions as a spacer for permeate flow to minimize pressure drop, so that the length of the module can be set regardless of pressure drop, and the heat loss of the mixture can be minimized by allowing the mixture to flow into the hollow fiber membranes.

Although the present invention has been described for illustrative purposes with reference to the accompanying drawings and embodiments, those skilled in the art will appreciate that various modifications, additions and substitutions are possible, without departing from the scope and spirit of the invention as disclosed in the accompanying claims.

1-14. (canceled)

15. A hollow fiber membrane, comprising:
a hollow, tubular braid portion of a number of spiraled, bare, metal wires and a number of spiraled polymer fibers therebetween; and
a tubular active layer portion formed on an inner surface of the tubular braid portion and including an outer porous layer and an inner active layer that is more compact than the outer porous layer.

16. The membrane of claim 15, wherein the polymer fibers are selected from the group consisting of: polyester fiber, nylon fiber, aramid fiber, polypropylene fiber, and polyethylene fiber.

17. The membrane of claim 15, wherein the metal wires are selected from the group consisting of: copper wire, nickel wire, stainless steel wire, tin wire, and nichrome wire.

18. The membrane of claim 15, wherein an outer diameter of the active layer portion before braiding is 1.1-3.0 times the inner diameter of the braid portion formed without the active layer.

19. The membrane of claim 15, wherein each of the metal wires is either a single metal wire having a diameter of 0.05-0.40 mm or a metal wire assembly consisting of 2-5 thin metal wires.

20. The membrane of claim 15, wherein a total number of strands of the metals wires and polymer fibers in the braided portion is 10-80.

21. The membrane of claim 20, wherein the number of metal wires is 5-30% of the total number of strands.

22. The membrane of claim 15, wherein each of the metal wires is equally spaced from adjacent metal wires.

23. The membrane of claim 15, wherein the active layer portion is a nanofiltration membrane, a reverse osmosis membrane, a vapor permeation membrane, a pervaporation membrane, or a gas separation membrane.
